(19) United States
(12) Patent Application Publication
(10) Pub. No.: US 2009/0000928 A1
(43) Pub. Date: Jan. 1, 2009

(54) Electric Micro-Contactor for a Circuit Card and Electric Switch Comprising One Such Micro-Contactor

(75) Inventors: Stephane Vanhelle, Marignier (FR); Rene Ducruet, Cranves-Sales (FR); Laurent Mounier, Annemasse (FR)

Correspondence Address: OSHA LIANG L.L.P., TWO HOUSTON CENTER, 909 FANNIN, SUITE 3500, HOUSTON, TX, 77010, US

(73) Assignee: DAV Societe Anonyme, Creteil (FR)

(21) Appl. No.: 11/630,809

(22) PCT Filed: May 16, 2005
(86) PCT No.: PCT/EP2005/052228

§ 371 Date: Jul. 28, 2008

(30) Foreign Application Priority Data
Jun. 29, 2004 (FR) 04/07213

(51) Int. Cl. H01H 9/00

(52) U.S. Cl. 200/292

(57) ABSTRACT

An electrical microcontact for printed circuit boards is adapted to make an electrical contact between two associated connecting areas of a circuit board. The microcontact includes a metal plate having a generally U-shaped first portion each of the branches whereof has at its end reflow areas adapted to be connected by the reflow process to associated connecting areas of the circuit board and a second portion taking the form of a central tongue connected in one piece to the base of the U and extending between the two branches of the U, this tongue being inclined relative to a plane defined by the U in such a manner that pressing on a pressure area situated toward the free end of the tongue makes electrical contact between a contact area of the tongue and the associated connecting area of the printed circuit board.

The present invention relates to an electrical microcontact for circuit boards adapted to make an electrical contact between two associated connection areas of a circuit board and to an electrical switch equipped with such a microcontact.

It is applied in the automotive context in particular and especially for producing contacts for door switch panels, for example for opening and closing the windows and for controlling the orientation of the rear-view mirrors, in particular for control by voltage levels.

There exist in the automobile numerous electrical components such as electrical switches that have one or more contact pins intended to be fixed to the printed circuit board.

Traditionally, the process of soldering these switches necessitates an independent mechanical fixing of the switch to the printed circuit board whereby the pins pass through holes formed in the board and hold the switch on the board by elastic means, for example clip means. The electrical connections are then made by soldering at locations distant from the holes.

Such switches are known from patent application FR2825510 in the name of the Applicant. All of the description of that application is considered as incorporated in the present application.

The switches described in that application have microcontacts that all have plug-in terminals that are passed through the printed circuit board at the mounting stage to ensure strong mechanical retention of the microcontact on the board. In fact, this strong attachment is necessary to avoid detachment of the soldered joints after many mechanical loading cycles.

Additionally, it has been found that the holes formed in the board cause sealing problems.

To avoid having to provide fixing holes in the circuit board, it would be desirable to apply the reflow soldering technique to these components.

In fact, in the fabrication of electrical and/or electronic modules of the type including electrical and/or electronic components mounted on a printed circuit board, surface mount components, usually called SMC components, are increasingly used. To this end, the SMC components, provided with appropriate connecting leads, are placed on conductive areas on the surface of a printed circuit board that have previously been coated with a solder paste by a screenprinting technique, after which the printed circuit board carrying the SMC components is placed in a reflow oven in order to solder the connecting leads of the SMC components to their respective conductive areas on the printed circuit board.

Now, the mechanical stresses on such microcontacts when the switch is operated do not allow simple replacement of plug-in fixing terminals by reflow connection areas.

The present invention aims to propose a microcontact that can be fitted by a reflow process without necessitating plug-in mechanical fixings.

To this end, the invention consists in an electrical microcontact for printed circuit boards, adapted to make an electrical contact between two associated connecting areas of a circuit board, characterized in that it comprises a metal plate having a generally U-shaped first portion each branch whereof has at its end reflow areas adapted to be connected by the reflow process to associated connecting areas of the circuit board and a second portion taking the form of a central tongue connected in one piece to the base of the U and extending between the two branches of the U, this tongue being inclined relative to a plane defined by the U in such a manner that pressing on a pressure area situated toward the free end of the tongue makes electrical contact between a contact area of the tongue and the associated connecting area of the circuit board.

The invention also consists in an electrical switch, in particular for an automobile vehicle, characterized in that it comprises a circuit board and at least one microcontact as defined hereinabove mounted by the reflow process on associated connecting areas of the circuit board.

Other features and advantages of the invention will emerge from the following description, given by way of nonlimiting example, with reference to the appended drawings, in which:

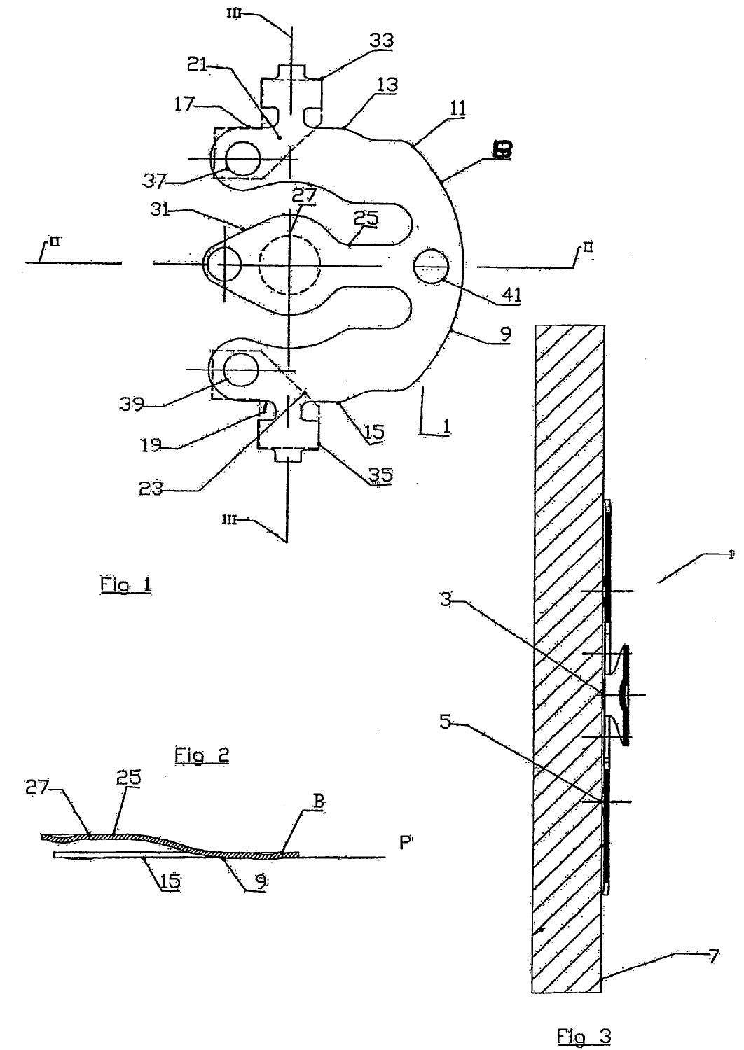

FIG. 1 is a view from above of a microcontact according to the invention,

FIG. 2 is a view of the microcontact from FIG. 1 in section taken along the line II-II, and

FIG. 3 is a view of the microcontact from FIG. 1 mounted on a printed circuit board in cross section taken along the line III-III in FIG. 1.

A nonlimiting embodiment of the invention will be described hereinafter with reference to the three appended figures.

The electrical microcontact 1 for circuit boards is adapted to make electrical contact between two associated connecting areas 3 and 5 of a circuit board 7 (see FIG. 3).

The circuit board is a printed circuit board or a cut-out and overmolded circuit board, for example. Thus the expression “circuit board” means any support comprising circuits to which components may be soldered.

This microcontact 1 comprises a metal plate 9 having a first portion 11 that is generally U-shaped, the branches 13 and 15 whereof each have at their ends 17 and 19 reflow areas 21 and 23 (represented in dashed line) adapted to be connected by the reflow process to associated connecting areas 5 of the printed circuit board 7.

The plate 9 has a second portion 25 in the form of a central tongue connected in one piece to the base B of the U and extending between the two branches of the U.

As seen in FIG. 2, this tongue 25 is inclined relative to a plane P defined by the U so that pressing on a pressure area 27 (represented in dashed line) situated toward the free end of the tongue 25 makes electrical contact between a contact area of the tongue 27 and the associated connecting area 3 of the printed circuit board 7.

To optimize tactile manipulation of the microcontact via a piston, not shown, the end of the tongue takes the form of an end pad 31 with a widened portion in the pressure area 27.

The reflow connecting areas of the branches 21 and 23 of the plate advantageously define a geometrical line passing through the end pad 31 of the tongue 27. In the figure, this line is materialized by the section line III-III.

Thus, pressing on the area 27 causes the branches and in particular the reflow areas to be pressed against the printed circuit board 7, while the base B of the U of the plate 9 may be slightly raised.

There is thus obtained a great reduction of the mechanical loads on the reflow soldered joints of the microcontact, which ensures a large number of operating cycles as well as enabling the use of an economical reflow process.

The metal plate 9 is advantageously made by cutting it out and stamping it, preferably from a metal strip, which means that the mounting of these microcontacts may be completely automated and the mounting station fed with a roll of strip comprising the microcontacts according to the invention.

The reflow contact may optionally be strengthened by additionally providing for each branch a lateral reflow connecting lug 33 and 35 connected in one piece to the associated branch.

The two lateral connecting lugs 33 and 35 are preferably situated substantially on said geometrical line III-III and are preferably generally square or circular in shape.

For better positioning of the metal plate on the printed circuit board, the end area of each branch of the U and the base B of the U each include a stamped portion 37, 39 and 41 for positioning the microcontact on a printed circuit board at the mounting stage.

To mount the microcontact 1 according to the invention on a printed circuit board 7, its attachments to the strip are cut and the microcontact is positioned on electrical contact areas of the printed circuit board 7 previously coated with an appropriate solder paste.

The whole then enters a reflow oven.

Thus, without providing independent mechanical fixing by means of holes, one or more microcontacts are easily connected to a printed circuit board mechanically and electrically. This is all the more remarkable in that, in the electrical circuit, the microcontact is an active element both mechanically and electrically, whereas normally components mounted by the reflow process are not mechanically loaded during their operation (mechanically passive).

1. An electrical microcontact for printed circuit boards, adapted to make an electrical contact between two associated connecting areas of a circuit board, characterized in that it comprises a metal plate having a generally U-shaped first portion each of the branches whereof has at its end reflow areas adapted to be connected by the reflow process to associated connecting areas of the circuit board and a second portion taking the form of a central tongue connected in one piece to the base of the U and extending between the two branches of the U, this tongue being inclined relative to a plane defined by the U in such a manner that pressing on a pressure area situated toward the free end of the tongue makes electrical contact between a contact area of the tongue and the associated connecting area of the printed circuit board.

2. The microcontact according to claim 1, characterized in that the tongue has an end pad with a widened portion in the pressure area.

3. The microcontact according to claim 2, characterized in that the reflow connection areas of the branches of the plate define a geometrical line passing through the end pad of the tongue.

4. The microcontact according to claim 1, characterized in that said plate is produced by a cutting and stamping process.

5. The microcontact according to claim 3, characterized in that each branch also has a lateral reflow connecting lug connected in one piece to the associated branch.

6. The microcontact according to claim 5, characterized in that the two lateral connecting lugs are situated substantially on said geometrical line.

7. The microcontact according to claim 5, characterized in that each connecting lug is generally square in shape.

8. The microcontact according to claim 5, characterized in that each connecting lug is generally circular in shape.

9. The microcontact according to claim 1, characterized in that the end area of each branch of the U and the base of the U each include a stamped portion for positioning the microcontact on a printed circuit board at the mounting stage.

10. An electrical switch, in particular for an automobile vehicle, characterized in that it comprises a circuit board and at least one microcontact mounted by a reflow process on associated connecting areas of the circuit board, wherein the microcontact comprises:
a metal plate having a generally U-shaped first portion, each of the branches whereof has at its end reflow areas adapted to be connected by the reflow process to associated connecting areas of the circuit board and a second portion taking the form of a central tongue connected in one piece to the base of the U and extending between the two branches of the U, this tongue being inclined relative to a plane defined by the U in such a manner that pressing on a pressure area situated toward the free end of the tongue makes electrical contact between a contact area of the tongue and the associated connecting area of the printed circuit board.

11. The microcontact according to claim 2, characterized in that said plate is produced by a cutting and stamping process.

12. The microcontact according to claim 3, characterized in that said plate is produced by a cutting and stamping process.

13. The microcontact according to claim 1, characterized in that each branch also has a lateral reflow connecting lug connected in one piece to the associated branch.

14. The microcontact according to claim 2, characterized in that each branch also has a lateral reflow connecting lug connected in one piece to the associated branch.

15. The microcontact according to claim 4, characterized in that each branch also has a lateral reflow connecting lug connected in one piece to the associated branch.

16. The microcontact according to claim 6, characterized in that each connecting lug is generally square in shape.

17. The microcontact according to claim 6, characterized in that each connecting lug is generally circular in shape.
